(19) United States
(12) Patent Application Publication
(10) Pub. No.: US 2006/0013162 A1
(43) Pub. Date: Jan. 19, 2006

(54) Portable digital device and service system having iSCSI-based remote storage service function in wireless environment

(75) Inventor: Hyo Taek Lim, Busan (KR)

Correspondence Address: VOLPE AND KOENIG, P.C., UNITED PLAZA, SUITE 1600, 30 SOUTH 17TH STREET, PHILADELPHIA, PA, 19103, US

(73) Assignees: Hyo Taek Lim, Busan (KR); Dongseo University, Busan (KR)

(21) Appl. No.: 11/166,446

(22) Filed: Jun. 24, 2005

(30) Foreign Application Priority Data
Jul. 16, 2004 (KR) 10-2004-0055409

(51) Int. Cl. H04Q 7/00

(52) U.S. Cl. 370/328

(57) ABSTRACT

The present invention relates to a portable digital device and service system having an Internet over Small Computer Systems Interface (iSCSI)-based remote storage service function in a wireless environment. The object of the present invention is to overcome the problem in which a conventional iSCSI network storage system in a wired iSCSI client environment can operate on a Windows or Linux platform but cannot operate in the environment of a portable digital device, such as a Personal Digital Assistant (PDA), that operates on a wireless network. In the present invention, an iSCSI initiator driver unit is installed on a portable digital device operating on a wireless network, so that data can be stored on the Small Computer Systems Interface (SCSI) disk of a remote target computer and stored data can be read from the SCSI disk. The present invention has the advantage of allowing iSCSI storage service to be used on a portable digital device in a wireless network environment.

### BACKGROUND OF THE INVENTION

1. Field of the Invention

The present invention relates generally to remote data storage in a wireless environment and, more particularly, to a portable digital device and service system having an Internet over Small Computer Systems Interface (iSCSI)-based remote storage service function in a wireless environment, in which an iSCSI initiator driver unit is mounted in the portable digital device on a wireless network, so that data can be stored on a Small Computer Systems Interface (SCSI) disk of a target computer in a remote place and stored data can be read from the SCSI disk.

2. Description of the Related Art

Current data storage service has attained a technology capable of utilizing a virtual storage disk in a remote place. A representative service for implementing such a technology is iSCSI service. iSCSI is a protocol that transmits storage traffic in a Transmission Control Protocol/Internet Protocol (TCP/IP) network in units of blocks.

FIG. 1 is a block diagram showing a prior art iSCSI-based remote storage service system.

As shown in FIG. 1, an iSCSI client 110 in which the iSCSI protocol is implemented is coupled to a TCP/IP network 130 via a wired connection, so that the iSCSI client 110 can use the SCSI disk 142 of a target computer 140, that is, a remote storage server, as if the SCSI disk 142 were its own local storage device.

However, the prior art iSCSI-based remote storage service system has the following problems.

In the prior art iSCSI-based remote storage service system, the iSCSI client 110 is coupled to the TCP/IP network 130 via a wired connection, as shown in FIG. 1, and uses the SCSI disk 142 of the target computer 140.

Accordingly, the iSCSI network storage in the wired environment of the prior art iSCSI client 110 can operate in a Windows or Linux environment, but it cannot operate in the environment of portable digital devices, such as a Moving Picture Experts Group-1 Audio Layer-3 (MP3) player, that operate in a wireless network.

The reason for this is that the construction of the kernel of the portable digital devices, such as an MP3 player, which is used in an embedded system, is considerably different from that of general workstations.

That is, the construction of the kernel of the portable digital devices is implemented depending on a corresponding embedded system, so that the construction of a kernel of the portable digital devices is considerably different from that of general workstations. As a result, the prior art iSCSI-based storage networking technology cannot be applied to portable digital devices, such as an MP3 player, that operate in a wireless network.

Furthermore, since prior art iSCSI protocol parameters for a wired environment do not coincide with iSCSI protocol parameters for a wireless network environment, a problem arises in that prior art iSCSI-based storage networking technology cannot be applied to portable digital devices, such as a Personal Digital Assistant (PDA), that operate on a wireless network, as it is.

### SUMMARY OF THE INVENTION

Accordingly, the present invention has been made keeping in mind the above problems occurring in the prior art, and an object of the present invention is to provide a portable digital device having an iSCSI-based remote storage service function in a wireless environment, in which an iSCSI initiator driver unit is mounted in the portable digital device on a wireless network, so that data can be stored on the SCSI disk of a target computer in a remote place and stored data can be read from the SCSI disk.

In order to accomplish the above object, the present invention provides a portable digital device having an iSCSI-based remote storage service function in a wireless environment, the portable digital device including a wireless communication module for interfacing with a wireless network; memory for storing a program that accesses a target computer, that is, a remote storage server, in wireless network and TCP/IP network environments, generates command data requesting the write/read of data to/from a SCSI disk located in the target computer, and provides an iSCSI; and a central processing unit for reading the program from the memory, executing the program and controlling the entire portable digital device.

Additionally, the present invention provides a portable digital device having an iSCSI-based remote storage service function in a wireless environment, the portable digital device including a wireless communication module for interfacing with a wireless network; a local file system for storing and managing files used to operate a system; a block device driver for operating a SCSI disk located in a target computer; a SCSI device driver for operating a SCSI device operating on a SCSI basis of the target computer; an iSCSI initiator driver for negotiating and controlling transmission and reception parameters so that the parameters are suitable for wireless network and TCP/IP network environments, generating a PDU and providing a SCSI interface; a wireless LAN driver for interfacing with the wireless network for transmission of the iSCSI PDU data; and a CPU for controlling an entire construction of the portable digital device.

Preferably, the portable digital device may be a mobile device.

Preferably, the portable digital device may be any one of a PDA, a personal communication services phone and a cellular phone.

Preferably, the portable digital device may be any one of an MP3 player, a digital camera, a digital camcorder, a closed-circuit television, a portable web pad, a digital television, a digital video camera, a digital versatile disk player, a portable multimedia player and a digital set-top box.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing a prior art iSCSI-based remote storage service system;

FIG. 2 is a block diagram showing an iSCSI-based remote storage service system in a wireless environment in accordance with an embodiment of the present invention;

FIG. 3 is a block diagram showing an embodiment of the PDA of FIG. 2;

FIG. 4 is a block diagram showing the detailed construction of the memory of FIG. 3;

FIG. 5 is a block diagram showing the detailed construction of the iSCSI initiator driver unit of FIG. 4;

FIG. 6 is a detailed block diagram showing a second embodiment of the PDA of FIG. 2; and

FIG. 7 is a block diagram showing the detailed construction of the iSCSI initiator driver unit of FIG. 6.

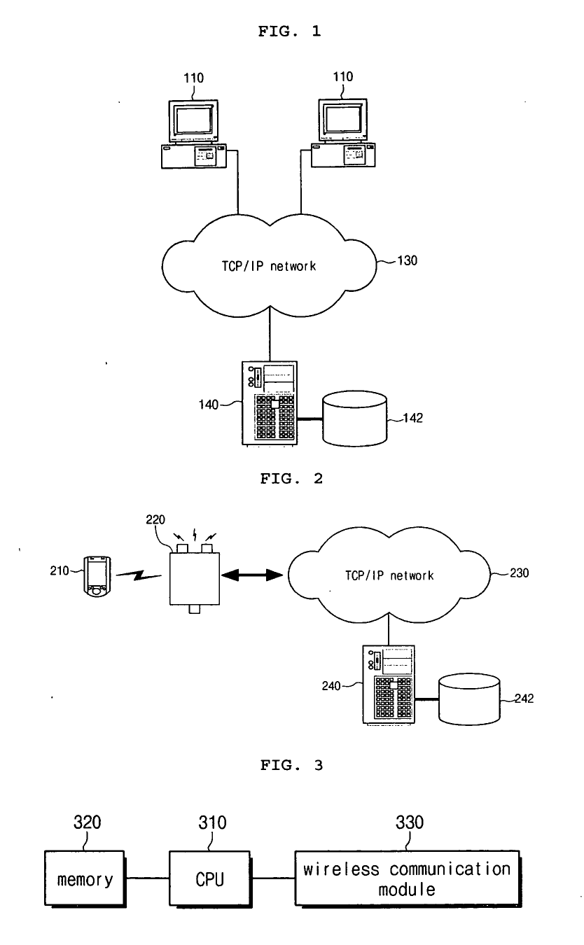

### DESCRIPTION OF THE PREFERRED EMBODIMENTS

Reference now should be made to the drawings, in which the same reference numerals are used throughout the different drawings to designate the same or similar components.

A preferred embodiment of a portable digital device having an iSCSI-based remote storage service function in a wireless environment is described in detail with reference to the accompanying drawings.

The term “portable digital device” in the present invention refers to a device that digitally processes data such as text, audio and images, and stores digital information corresponding to the data in the form of digital signals.

FIG. 2 is a block diagram showing an iSCSI-based remote storage service system in a wireless environment in accordance with an embodiment of the present invention.

As shown in FIG. 2, in the iSCSI-based remote storage service system in a wireless environment in accordance with the embodiment of the present invention, a PDA 210, that is, a storage client, is connected to a target computer 240, that is, a storage server, via a wireless network and a Transmission Control Protocol (TCP)/Internet Protocol (IP) network 230. Furthermore, an access point 220 connects the PDA 210 with the TCP/IP network 230 via the wireless network.

The PDA 210 is provided with the iSCSI-based remote storage service function in a wireless environment in accordance with the present invention, so that the PDA 210 requests iSCSI-based remote storage service, that is, the read/write of data, from the target computer 240 and receives data from the target computer 240, and the target computer 240 has the authority to control access to the PDA 210, writes/reads data to/from a SCSI disk 242 at the request of the PDA 210 and transmits data, which are stored in the SCSI disk 242, to the PDA 210. The SCSI disk 242 is a storage device that is located in the target computer 240 and reads/writes data at the request of the PDA 210.

FIG. 3 is a detailed block diagram showing an embodiment of the PDA 210 shown in FIG. 2.

As shown in FIG. 3, the PDA 210, that is, a portable digital device having the iSCSI-based remote storage service function in a wireless environment, in accordance with the embodiment of the present invention, includes a Central Processing Unit (CPU) 310, memory 320 and a wireless communication module 330.

The wireless communication module 330 functions to interface the PDA 210 with the wireless network for data. That is, the wireless communication module 330 refers to a comprehensive construction, including a Radio Frequency (RF) processing unit, an Intermediate Frequency (IF) processing unit and a baseband processing unit. The wireless communication module 330 primarily processes a radio communication frequency, performs IF processing that lowers the processed radio communication frequency to an IF, and lowers the IF to a baseband frequency that can be processed in the CPU 310, thereby producing a bit string. Furthermore, the wireless communication module 330 is divided into a reception unit (not shown) and a transmission unit (not shown). The reception unit of the wireless communication module 330 maximally suppresses the amplification of noise, amplifies a desired signal, and generates a digital signal through an IF frequency. The generated signal is analyzed and processed in the CPU 310. In contrast, the transmission unit of the wireless communication module 330 modulates the signal, which is generated in the CPU 310, into a desired frequency band, amplifies the modulated signal, and finally radiates the amplified signal via a duplex (not shown) and an antenna (not shown).

The memory 320 stores a program that allows the PDA 210 to perform an iSCSI storage service together with the target computer 240 via the wireless network and the TCP/IP network 230.

In more detail, the memory 320 stores the program that generates command data for accessing the target computer 240, that is, a remote storage server, in a wireless and TCP/IP network environment and requesting the read/write of data from/to the SCSI disk 242 of the target computer 240, and that provides an iSCSI interface.

The CPU 310 reads the program from the memory 320, executes respective processes and controls the entire construction of the PDA 210.

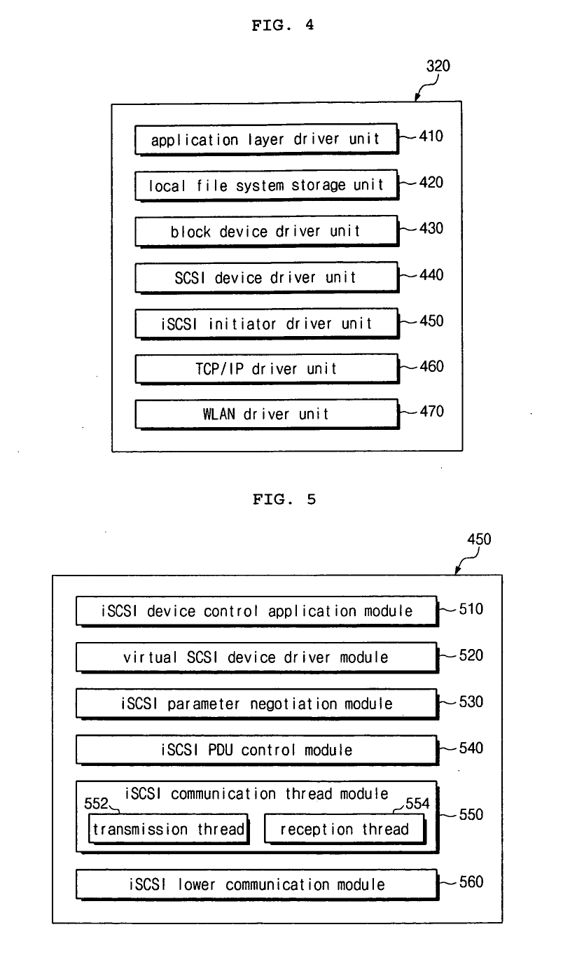

FIG. 4 is a block diagram showing the detailed construction of the memory 320.

As shown in FIG. 4, the memory 320 includes an application layer driver unit 410 for making a request for the read/write of data from/to the SCSI disk 242 in compliance with a user's command, a local file system storage unit 420 for storing files for system operation, a block device driver unit 430 for operating the SCSI disk 242 located in the target computer 240, a SCSI device driver unit 440 for operating a SCSI device operating on the SCSI basis of the target computer 240, an iSCSI initiator driver unit 450 for negotiating and controlling transmission and reception parameters so that they are suitable for the environment of the wireless network and the TCP/IP network 230, generating an iSCSI Protocol Data Unit (PDU) and providing a SCSI interface, and a wireless Local Area Network (LAN) driver unit 470 for interfacing with the wireless network for the transmission of the iSCSI PDU data that are generated by the iSCSI initiator driver unit 450. Furthermore, a TCP/IP driver unit 460 interfaces with the TCP/IP network 230 for the transmission of data that are output from the PDA 210.

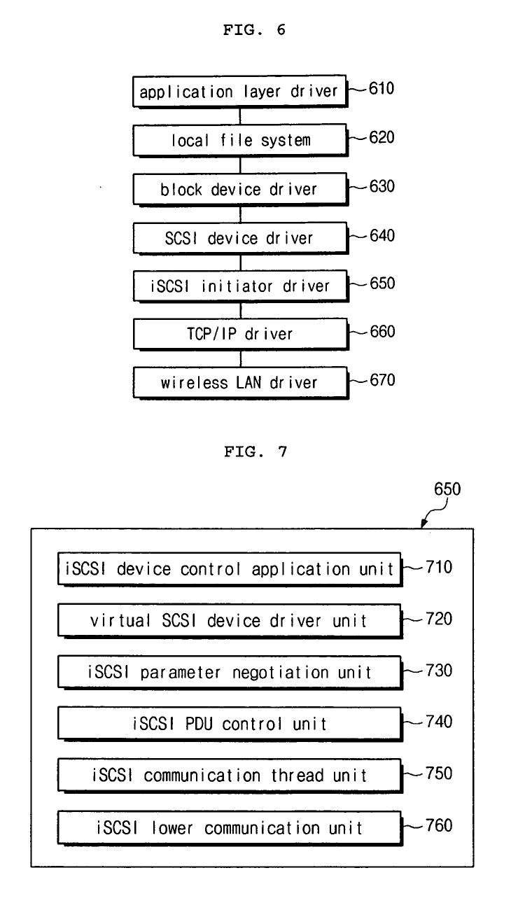

FIG. 5 is a block diagram showing the detailed construction of the iSCSI initiator driver unit 450 of FIG. 4.

As shown in FIG. 5, the iSCSI initiator driver unit 450 includes an iSCSI device control application module 510 for controlling the parameters of the iSCSI protocol at a user level so that they are suitable for the wireless network environment, a virtual SCSI device driver module 520 for registering a virtual SCSI host at a kernel level, an iSCSI parameter negotiation module 530 for negotiating parameter values in the login phase of the PDA 210, an iSCSI PDU control module 540 for generating an iSCSI PDU by including a SCSI Command Description Block (CDB), an iSCSI header and a TCP/IP header and controlling the iSCSI PDU, an iSCSI communication thread module 550 for exchanging the iSCSI PDU, which is generated by the iSCSI PDU control module 540, with the target computer 240, and an iSCSI lower communication module 560 for allowing data, which are transmitted and received to and from the iSCSI communication thread module 550, to be input and output at the kernel level.

The iSCSI communication thread module 550 includes a transmission thread 552 for performing the transmission of data to the target computer 240 and a reception thread 554 for performing the reception of data from the target computer 240.

FIG. 6 is a detailed block diagram showing a second embodiment of the PDA 210 of FIG. 2.

The PDA 210 of the second embodiment of the present invention, which is shown in FIG. 6, includes a wireless communication module (not shown), a CPU (not shown), an application layer driver 610, a local file system 620, a block device driver 630, a SCSI device driver 640, an iSCSI initiator driver 650, a TCP/IP driver 660 and a wireless LAN driver 670.

The wireless communication module has the same construction and function as the wireless communication module 330 of FIG. 3, and the CPU controls the entire construction of the PDA 210.

The application layer driver 610 functions to run an application program in compliance with a user's command and the local file system 620 stores and manages files used to operate the system.

The block device driver 630 operates the SCSI disk 242 located in the target computer 240, the SCSI device driver 640 operates the SCSI device operating on the SCSI basis of the target computer 240, and the iSCSI initiator driver 650 negotiates and controls transmission and reception parameters so that they are suitable for wireless network and TCP/IP network environments, generates an iSCSI PDU and provides a SCSI interface.

The wireless LAN driver 670 interfaces with a wireless network for the transmission of data that are generated by the iSCSI initiator driver 650.

FIG. 7 is a block diagram showing the detailed construction of the iSCSI initiator driver 650 of FIG. 6. As shown in FIG. 7, the iSCSI initiator driver 650 includes an iSCSI device control application unit 710, a virtual SCSI device driver unit 720, an iSCSI parameter negotiation unit 730, an iSCSI PDU control unit 740, an iSCSI communication thread unit 750 and an iSCSI lower communication unit 760.

The iSCSI device control application unit 710 controls the parameters of the iSCSI protocol at a user level so that they are suitable for the wireless network environment, and the virtual SCSI device driver unit 720 registers a virtual SCSI host at a kernel level.

The iSCSI parameter negotiation unit 730 negotiates parameter values in the login phase of the PDA 210, and the iSCSI PDU control unit 740 generates an iSCSI PDU by including a CDB, an iSCSI header and a TCP/IP header, and controls the iSCSI PDU.

The iSCSI communication thread unit 750 exchanges the iSCSI PDU with the target computer 240, and the iSCSI lower communication unit 760 allowing data, which are transmitted and received to and from the iSCSI communication thread unit 750, to be input and output at the kernel level.

The operation of the portable digital device and service system having the iSCSI-based remote storage service function in the wireless environment in accordance with the present invention is described below.

The operation of an iSCSI-based remote storage service in a wireless environment in accordance with the embodiment of the present invention, which is based on FIGS. 2 to 5, is described below.

When a command is input using a wireless network storage service function key (not shown) provided in the key input unit (not shown) of the PDA 210, the CPU 310, which becomes aware of the command, reads the program from the memory 320 and executes respective processes.

In more detail, when the user inputs the command through the wireless network storage service function key, the application layer driver unit 410 at a user level makes a request for the read/write of data from/to the SCSI disk 242 of the target computer 240, the request is transferred to the iSCSI initiator driver unit 450 through the local file system storage unit 420 and the block device driver unit 430 at a kernel level that is lower than the user level, and the iSCSI initiator driver unit 450 transmits data to the remote target computer 240 through a TCP/IP-based iSCSI connection path.

In other words, the iSCSI initiator driver unit 450 generates an iSCSI PDU, including an iSCSI CDB, an iSCSI header and a TCP/IP header, and transmits data to the remote target computer 240 through a TCP/IP connection formed on the PDA 210.

The operation of the iSCSI initiator driver unit 450 is described in more detail.

The process of connecting the PDA 210, that is, the portable digital device having the iSCSI protocol-based remote storage service function in the wireless environment, with the target computer 240 includes two phases: a login phase, in which parameters used for the transmission and reception of data are negotiated, and a pull feature phase, in which data are actually transmitted and received.

The original iSCSI protocol was designed for a Gigabit Ethernet environment, whereas the portable digital device, such as the PDA, to which the present invention is applied, can operate in a limited wireless network environment. Accordingly, in the login phase, control needs to be performed so that parameters related to the transmission and reception of data can be suitable for the wireless environment.

The iSCSI device control application module 510 controls transmission and reception parameters at a user level so that the transmission and reception parameters can be suitable for the wireless environment. Such control at the user level is the basis of a connection to the target computer 240 and provides the control of basic SCSI protocol parameter values.

The above-described work can be performed at the kernel level by the virtual SCSI device driver module 520. The virtual SCSI device driver module 520 registers a host at the kernel level on the portable digital device, such as the PDA 210, in which a SCSI host adaptor does not exist, as if the SCSI host existed thereon.

The negotiation of parameter values, which is performed in the login phase, is performed by the iSCSI parameter negotiation module 530. The parameters used in the negotiation of parameters are composed of text values, and the iSCSI parameter negotiation module 530 communicates with a parameter negotiation module existing on the target computer 240.

After the parameter values have been negotiated, security policies are negotiated using an iSCSI security negotiation module (not shown) that is lower than the iSCSI parameter negotiation module. Since the iSCSI protocol is an open TCP/IP network-based protocol, the negotiation of a security model is necessary at the time of setting up an iSCSI connection. Like the above-described case, the iSCSI security negotiation module communicates with a security module (not shown) provided in the target computer 240. Furthermore, the iSCSI parameter negotiation module 530 performs a user authentication function as well.

After the login phase has been completed through the above-described process, the full feature phase, in which actual data are transmitted and received in the iSCSI protocol environment, is performed.

The transmission of actual data in the full feature phase is performed in units of iSCSI PDUs, where the iSCSI PDU is a transmission unit, including a TCP/IP header, an iSCSI header, and a SCSI command.

A single complete iSCSI PDU is produced by the iSCSI PDU control module 540 in such a way as to include an iSCSI header used to control the flow of the iSCSI protocol and a TCP/IP header related to actual transmission on the basis of a CDB, which is called from the higher-level virtual SCSI device driver module 520, and call-related data (iSCSI PDU Encapsulation).

Furthermore, in reverse, the iSCSI PDU, which is received from the target computer 240, except the TCP/IP header and the iSCSI header, that is, the CDB and the corresponding data, is transmitted to the higher-level virtual SCSI device driver module 520 by the iSCSI PDU control module 540 (iSCSI PDU Decapsulation).

After the above process has been performed, iSCSI PDU entities are transmitted and received by the iSCSI communication thread module 550.

Based on a transmission limitation length negotiated in the login phase, Vector Input/Output (I/O)-based iSCSI PDU transmission and reception are performed via thread-based communication to improve a vector performance time.

Furthermore, the transmission thread 552 and the reception thread 554 communicate with the transmission and reception thread modules of the target computer 240, respectively.

Meanwhile, the system program for implementing the portable digital device and the service system having the iSCSI-based remote storage service function in a wireless environment in accordance with the present invention implements the input and output of data at the kernel level, so that it is constructed using lower internal kernel modules, which means that the transmission and reception of data are performed using a system socket module that is lower than a user socket interface.

Furthermore, the actual transmission of data on the network at the kernel level is achieved by the provision of the iSCSI lower communication module 560.

Meanwhile, since the operation of the second embodiment according to the present invention is the same as that of the first embodiment, a detailed description thereof is omitted here.

As described above, the present invention implements the iSCSI protocol on a portable digital device, such as a PDA. Since the portable digital device, such as a PDA, is an embedded system, the portable digital device having the iSCSI-based remote storage service function in the wireless environment in accordance with the present invention and a system program implementing a service system are constructed depending on the kernel system of the PDA.

Although, in the embodiments of the present invention, the case where the portable digital device of the present invention is a PDA is given as an example, the portable digital device is not limited to this case. That is, the case where the portable digital device is a mobile device, such as a Personal Communication Services (PCS) phone or a cellular phone, falls within the scope of the rights of the present invention.

Although, in the embodiment of the present invention, the case where the portable digital device of the present invention is a PDA is given as an example, the portable digital device is not limited to this case. That is, the case where the portable digital device of the present invention is a portable digital device, such as an MP3 player, a digital camera, a digital camcorder, a Closed-Circuit Television (CCTV), a portable web pad, a Digital Television (DTV), a Digital Video Camera (DVC), a Digital Versatile Disk Player (DVDP), a Portable Multimedia Player (PMP) or a digital set-top box, falls within the scope of right of the present invention.

The portable digital device and service system having the iSCSI-based remote storage service function in the wireless environment in accordance with the present invention, which have the above-described construction and operation, have the following advantages.

First, by implementing the iSCSI protocol in a portable digital device such as a PDA, a PCS phone, a cellular phone, an MP3 player, or a digital camera, an advantage arises in that the storage service on the target computer, that is, a remote storage server, can be utilized via the TCP/IP network even in a wireless network environment.

Second, the portable digital device and service system having the iSCSI-based remote storage service function in the wireless environment in accordance with the present invention allows a remote storage device to be recognized as the portable digital device's own local storage device, thus overcoming storage limitations.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A portable digital device having an Internet over Small Computer Systems Interface (iSCSI)-based remote storage service function in a wireless environment, the portable digital device comprising:
a wireless communication module for interfacing with a wireless network;
memory for storing a program that accesses a target computer, that is, a remote storage server, in wireless network and Transmission Control Protocol (TCP)/(IP) Internet Protocol network environments, generates command data requesting write/read of data to/from a Small Computer Systems Interface (SCSI) disk located in the target computer, and provides an iSCSI; and
a Central Processing Unit (CPU) for reading the program from the memory, executing the program and controlling the entire portable digital device.

2. The portable digital device as set forth in claim 1, wherein the memory comprises:
a local file system storage unit for storing and managing files for system operation;
a block device driver unit for operating the SCSI disk located in the target computer;
a SCSI device driver unit for operating a SCSI device operating on a SCSI basis of the target computer;
an iSCSI initiator driver unit for negotiating and controlling parameters transmission and reception so that the parameters are suitable for the wireless network and TCP/IP network environments, generating an iSCSI Protocol Data Unit (PDU) and providing the iSCSI interface; and
a wireless Local Area Network (LAN) driver unit for interfacing the wireless network for the iSCSI PDU.

3. The portable digital device as set forth in claim 2, wherein the iSCSI initiator driver unit comprises:
an iSCSI device control application module for controlling parameters of an iSCSI protocol at a user level so that the parameters are suitable for the wireless network environment;
a virtual SCSI device driver module for registering a virtual SCSI host at a kernel level;
an iSCSI parameter negotiation module for negotiating parameter values in a login phase of the portable digital device;
an iSCSI PDU control module for generating the iSCSI PDUS by including a Command Description Block (CDB), an iSCSI header and a TCP/IP head and controlling the iSCSI PDU;
an iSCSI communication thread module for exchanging the iSCSI PDU, which is generated by the iSCSI PDU control module, with the target computer; and
an iSCSI lower communication module for allowing data, which are transmitted and received to and from the iSCSI communication thread module, to be input and output at the kernel level.

4. The portable digital device as set forth in claim 1, wherein the portable digital device is a mobile device.

5. The portable digital device as set forth in claim 4, wherein the mobile device is any one of a Personal Digital Assistant (PDA), a Personal Communication Services (PCS) phone and a cellular phone.

6. The portable digital device as set forth in claim 1, wherein the portable digital device is any one of a Moving Picture Experts Group-1 Audio Layer-3 (MP3) player, a digital camera, a digital camcorder, a Closed-Circuit Television (CCTV), a portable web pad, a Digital Television (DTV), a Digital Video Camera (DVC), a Digital Versatile Disk Player (DVDP), a Portable Multimedia Player (PMP) and a digital set-top box.

7. A portable digital device having an iSCSI-based remote storage service function in a wireless environment, the portable digital device comprising:
a wireless communication module for interfacing with a wireless network;
a local file system for storing and managing files used to operate a system;
a block device driver for operating a SCSI disk located in a target computer;
a SCSI device driver for operating a SCSI device operating on a SCSI basis of the target computer;
an iSCSI initiator driver for negotiating and controlling transmission and reception parameters so that the parameters are suitable for wireless network and TCP/IP network environments, generating a PDU and providing a SCSI interface;
a wireless LAN driver for interfacing with the wireless network for transmission of the iSCSI PDU data; and
a CPU for controlling an entire construction of the portable digital device.

8. The portable digital device as set forth in claim 7, wherein the iSCSI initiator driver comprises:
an iSCSI device control application unit for controlling the parameters of the iSCSI protocol at a user level so that the parameters are suitable for the wireless network environment;
a virtual SCSI device driver unit for registering a virtual SCSI host at a kernel level;
an iSCSI parameter negotiation unit for negotiating parameter values in a login phase of the PDA;
an iSCSI PDU control unit for generating the iSCSI PDU by including a SCSI CDB, an iSCSI header and a TCP/IP header and controlling the iSCSI PDU;
n iSCSI communication thread unit for exchanging the iSCSI PDU, which is generated by the iSCSI PDU control unit, with the target computer; and
an iSCSI lower communication unit for allowing data, which are transmitted and received to and from the iSCSI communication thread unit, to be input and output at the kernel level.

9. An iSCSI-based remote storage service system in a wireless environment, the system comprising:
the portable digital device set forth in claim 1;
a wireless network and a TCP/IP network; and
a target computer connected to the portable digital device via the wireless network and the TCP/IP network, and configured to have authority to control access to the portable digital device, to write/read data at a request of the portable digital device, and to transmit data, which are stored in the SCSI disk, to the portable digital device.

10. The portable digital device as set forth in claim 2, wherein the portable digital device is a mobile device

11. The portable digital device as set forth in claim 3, wherein the portable digital device is a mobile device

12. The portable digital device as set forth in claim 2, wherein the portable digital device is any one of a Moving Picture Experts Group-1 Audio Layer-3 (MP3) player, a digital camera, a digital camcorder, a Closed-Circuit Television (CCTV), a portable web pad, a Digital Television (DTV), a Digital Video Camera (DVC), a Digital Versatile Disk Player (DVDP), a Portable Multimedia Player (PMP) and a digital set-top box.

13. The portable digital device as set forth in claim 3, wherein the portable digital device is any one of a Moving Picture Experts Group-1 Audio Layer-3 (MP3) player, a digital camera, a digital camcorder, a Closed-Circuit Television (CCTV), a portable web pad, a Digital Television (DTV), a Digital Video Camera (DVC), a Digital Versatile Disk Player (DVDP), a Portable Multimedia Player (PMP) and a digital set-top box.

14. An iSCSI-based remote storage service system in a wireless environment, the system comprising:
the portable digital device set forth in claim 2;
a wireless network and a TCP/IP network; and
a target computer connected to the portable digital device via the wireless network and the TCP/IP network, and configured to have authority to control access to the portable digital device, to write/read data at a request of the portable digital device, and to transmit data, which are stored in the SCSI disk, to the portable digital device.

15. An iSCSI-based remote storage service system in a wireless environment, the system comprising:
the portable digital device set forth in claim 3;
a wireless network and a TCP/IP network; and
a target computer connected to the portable digital device via the wireless network and the TCP/IP network, and configured to have authority to control access to the portable digital device, to write/read data at a request of the portable digital device, and to transmit data, which are stored in the SCSI disk, to the portable digital device.
